(19) United States
(12) Patent Application Publication
(10) Pub. No.: US 2021/0045351 A1
(43) Pub. Date: Feb. 18, 2021

(54) FISH IMPRINT KIT

(71) Applicant: PaperFin LLC, Chicago, IL (US)

(72) Inventor: Robert CHENOWETH, Chicago, IL (US)

(73) Assignee: PaperFin LLC, Chicago, IL (US)

(21) Appl. No.: 16/995,135

(22) Filed: Aug. 17, 2020

Related U.S. Application Data
(60) Provisional application No. 62/888,064, filed on Aug. 16, 2019.

(51) Int. Cl. A01K 11/00; B41M 3/00; A01K 97/00

(52) U.S. Cl. CPC A01K 11/00; B44C 5/06; A01K 97/00; B41M 3/001

(57) ABSTRACT

A kit for making an imprint of a surface of a fish without pigmented ink is disclosed. The kit comprises a developer-coated paper having a developer agent, a nonpigmented activation solution having an activation agent, an applicator, and a set of instructions for applying the activation solution to the surface of the fish with the applicator and making an imprint of the surface of the fish on the developer-coated paper. The developer agent and activation agent are selected so that they produce color when they are combined.

### INCORPORATION BY REFERENCE

This application claims priority from U.S. Provisional Application No. 62/888,064, filed on Aug. 16, 2019; and incorporates by reference the contents of the provisional application in its entirety.

### TECHNICAL FIELD

Kits and methods for making a two-dimensional imprint of an animal for ornamental purposes or for memorializing the appearance of individual organisms. More specifically, the kits and methods disclosed relate to making a two-dimensional imprint of fish.

### BACKGROUND

Nature printing is a useful art that involves recording the appearance of natural organisms. Methods and materials for various forms of nature printing have been available since at least the eighteenth century. A traditional Japanese method of printing fish, referred to as “gyotaku,” has been used for more than one hundred years to both produce ornamental prints and to memorialize a fisherman's catch.

Gyotaku generally requires the artist or fisherman to painstakingly prepare the fish for printing. The preparation may involve carefully cleaning the fish to removing mucus secretion, debris, and moisture. The fish, or certain anatomical features of the fish, may also require a supporting platform to hold it in place and ensure good results. Colored ink is generally applied to a surface of the fish, and then paper or silk is pressed to the surface of the fish to transfer the image of the fish to the paper or silk. Other forms of gyotaku involve adhering paper or silk to the fish and then gently and assiduously applying ink to the paper or silk with a silk applicator.

Modern conventional methods of producing fish prints generally require applying colored ink or dye to the fish and then pressing paper or fabric to the fish to transfer an image of the fish onto the paper or fabric. At least one method involves applying a solution to the fish that reacts with mucus secretion on the surface of the fish to produce a colored dye. The colored dye can then be transferred to paper or fabric.

Conventional materials and methods for printing a fish are generally difficult to use at the location where the fish is caught, particularly for the fisherman who is unlearned or unfamiliar with their necessary materials and techniques. Often the materials used for making a fish print can be harmful to fish or humans. And each of these methods requires the artist or fisherman to handle colored ink or dye on a fish that may be quite slippery; and the results can be messy.

### SUMMARY

Novel kits and methods for making an imprint of an animal for ornamental purposes or for memorializing the appearance of the animal are provided in this disclosure. Specifically, kits and methods are disclosed for making an imprint of a fish without pigmented ink. The kits and methods disclosed greatly simplify the process of making a print of a fish, enabling practitioners with little or no skill in such techniques to achieve suitable results.

A kit for making an imprint of a surface of a fish is disclosed. The kit includes a developer-coated paper having a developer agent, a nonpigmented activation solution having an activation agent, an applicator, and a set of instructions for applying the activation solution to the surface of the fish with the applicator and making an imprint of the surface of the fish on the developer-coated paper. The developer agent and activation agent are selected so that when they are combined they react to produce color.

In at least one aspect, the nonpigmented activation solution can be safe for topical use on the skin of an animal and for human handling. According to at least one embodiment, the nonpigmented activation solution can have a median lethal dose that is in the range of 300-2,000 milligrams per kilogram (mg/kg). In some aspects, the container has dimensions that allow the container to contain the developer-coated paper, nonpigmented activation solution, and applicator within. The container can be a hollow cylinder or tube with at least one resealable end. In some aspects, the applicator can be an absorbent material that is infused with the nonpigmented activation solution, and the applicator can be provided in sealed packaging. In some aspects, the absorbent material can be provided for absorbing moisture and cleaning the surface of the fish. In some aspects, the set of instructions can include species-specific instructions for applying the activation solution to the surface of the fish with the applicator and making an imprint of the surface of the fish on the developer-coated paper.

A method for making an imprint of a surface of a fish is disclosed. The method includes applying a nonpigmented activation solution to a surface of a fish, the nonpigmented activation solution having an activation agent, contacting a developer-coated paper having a developer agent with the surface of the fish so that the activation agent in the nonpigmented activation solution reacts with the developer agent of the developer-coated paper to produce color and form the imprint of surface of the fish on the developer-coated paper.

In some aspects, the activation agent and developer agent react quickly to produce color and form an imprint of a surface of the fish so that the imprint of the surface of the fish on the developer-coated paper can be handled after only a few seconds. According to at least one embodiment, the imprint of the fish on the developer-coated paper can be handled after only ten seconds of contacting the developer-coated paper with the surface of the fish without altering how the imprint of the surface of the fish appears and without discoloring the hands, alternately after only eight seconds, alternately after only five seconds, alternately after only three seconds. In some aspects, the step of contacting the surface of the fish with the developer-coated paper is carried out at ambient temperature. In at least one aspect, the nonpigmented activation solution has a median lethal dose that is in the range of 300-2,000 mg/kg. In some aspects, the fish can be a live fish that is released into a body of water after contacting the surface of the live fish with the developer coated paper. In some aspects, the surface of the fish can be cleaned to remove moisture and/or debris. In some aspects, the surface of the fish can be prepared by removing mucus secretion from the surface of the fish before applying the nonpigmented activation solution to the surface of the fish. In some aspects, the nonpigmented activation solution can be applied to the surface of the fish by wiping the nonpigmented activation solution onto the surface of the fish with an absorbent material. Any surface of the fish can be imprinted. In some aspects, the surface of the fish can be selected from the following: a surface of a bill of the fish, a surface of a fin of the fish, a surface of a tail of the fish, a surface of a side of a fish, a surface of a head of the fish, a surface of a gill of the fish, any combination of the same.

### BRIEF DESCRIPTION OF THE DRAWINGS

These and other features, aspects, and advantages of the scope will become better understood with regard to the following descriptions, claims, and accompanying drawings. However, the drawings illustrate only several embodiments and are therefore not to be considered limiting of the scope as it can admit to other equally effective embodiments.

FIG. 1 is a pictorial representation of an embodiment of a kit for making an imprint of a fish.

FIG. 2 is a pictorial representation of an embodiment of a kit for making an imprint of a fish, the kit having an activation solution-infused applicator.

FIG. 3 is a pictorial representation of an embodiment of a packaged kit for making an imprint of a fish.

FIG. 4 is a magnified illustration of an edge of developer-coated paper.

In the accompanying figures, similar components or features, or both, may have a similar reference label.

### DETAILED DESCRIPTION

While the scope of the kits and methods will be described with several embodiments, one of ordinary skill in the relevant art will appreciate that many examples, variations, and alterations to the composition and methods described here are within the scope and spirit of the disclosure.

Accordingly, the embodiments described are set forth without any loss of generality, and without imposing limitations on the disclosure. Those of ordinary skill in the relevant art will understand that the scope includes all possible combinations and uses of particular features described in the specification.

The kits and methods provided in this disclosure are directed to making an imprint of an animal for ornamental purposes or for memorializing the appearance of the animal. Specifically, kits and methods are disclosed for making an imprint of a fish without using pigmented ink.

As used throughout this disclosure, “fish” refers to a cold-blooded aquatic vertebrate animal.

As used throughout this disclosure, “developer agent” refers to a chemical agent that is a dye precursor that produces a chromophore (i.e., a chemical group responsible for giving color to a molecule) when reacted with an activation agent, and that is chemically stable when applied as a coating on paper. A developer agent does not refer to a chemical agent that reacts with a molecule to eliminate the preexisting color of that molecule.

As used throughout this disclosure, “activation agent” refers to a chemical agent that is a dye precursor that is capable of reacting with a developer agent to produce a molecule having color. An activation agent does not include a chemical agent that reacts with a molecule to eliminate the preexisting color of that molecule.

As used throughout this disclosure, “paper” refers to a thin sheet of material manufactured from a fibrous material such as wood pulp or recycled paper pulp.

As used throughout this disclosure, “developer-coated paper” refers to the product made by coating a paper substrate on at least one side with a developer agent. The developer coating on the developer-coated paper can have a pale or clear color such that the color of the paper substrate is substantially unaltered by the developer coating.

As used throughout this disclosure, “activation solution” refers to a fluid having a solvent and an activation agent. The term can include fluids having organic solvents or inorganic solvents; and can include aqueous solutions.

As used throughout this disclosure, “nonpigmented activation solution” refers to an activation solution with no added color. The nonpigmented activation solution can be transparent or translucent.

As used throughout this disclosure, “applicator” refers to a device suitable for applying the activation solution to a surface of a fish. Nonlimiting examples of applicators include cloths, brushes, foam, sponges, napkins, crepe paper, spatulas, squeegees, and gauze. It is contemplated that an applicator may also be an atomizer or sprayer.

As used throughout this disclosure, “absorbent material” refers to any material that can readily soak up liquid. Nonlimiting examples of absorbent material include sponge, cotton, gauze, crepe paper, fabric, and certain fibrous materials.

The kits and methods of this disclosure involve chemical agent dye precursors that are capable of reacting to produce color. The chemical agent dye precursors are referred to in this disclosure as developer agents and activation agents. When a developer agent is reacted with an activation agent, a molecule having a color is produced. The developer agent is applied to a paper substrate as a coating on at least one side of the paper substrate to produce a developer-coated paper. The developer-coated paper is typically stored at ambient temperature for a period of time, typically more than one week. The developer agent must remain chemically stable (i.e., not likely to undergo substantial physical change, radioactive decay, chemical decomposition, or chemical reaction) under such conditions when applied as a coating on the developer-coated paper.

Nonlimiting examples of developer agents include metal cations of metals such as nickel, mercury, cadmium, lead, zinc, copper, cobalt, and silver. Metal salts that produce metal ions (e.g., iron trichloride), their hydrates, and the like can also be used. A nonlimiting example of a suitable developer agent is nickel rosinate, which is substantially colorless and is chemically stable as a coating on paper. Because of these characteristics, nickel rosinate is sometimes also used in two-part “true inkless fingerprinting” applications.

Two-part “true inkless fingerprinting” involves applying a transparent or translucent solution to a body part such as a finger, and then pressing the body part to the coated surface of paper to produce an imprint of the body part. The transparent or translucent solution has a first chemical agent that reacts with a second chemical agent in the coated surface of the paper to produce color. Chemical agents that can be used in such two-part true inkless fingerprinting applications may be suitable for use as developer agents or activation agents; provided that the chemical agent reacts upon contact with its activation/developer agent counterpart to produce color without providing additional pressure, light, or heat energy.

Upon contact with the developer agent, the activation agent reacts with the developer agent to produce color. Activation agents can include a wide variety of chemical agents. In some embodiments an activation agent can be an organic compound that reacts with the developer agent to produce a metal complex chromophore. A nonlimiting example of an activation agent includes a N,N′-di-organo-substituted dithiooxamide complexing agent such as N,N-di-benzyl-dithiooxamide or N,N′-bis (2-octanoyloxyethyl) dithiooxamide. In at least one embodiment the activation agent is an organofluorine compound or fluorane. Another nonlimiting example of an activation agent includes isostearic acid.

The activation agent can be combined with a solvent to produce the activation solution. Preferably, the activation agent is completely soluble in the solvent. The solvent can be an organic or inorganic solvent. The solvent can be an aqueous solvent. The activation solution can be a nonpigmented activation solution. In some embodiments, the activation solution can be substantially nontoxic. Acute toxicity is sometimes quantified and reported as median lethal dose (LD₅₀). The median lethal dose of a toxin is the dose necessary to kill half of the members of a test population, such as laboratory rats or mice, and is expressed in this disclosure as milligrams of toxin ingested per kilogram of animal (mg/kg). A higher LD₅₀ is generally correlated with lower acute toxicity. In at least one embodiment, the activation solution has LD₅₀ between about 300 mg/kg and about 2,000 mg/kg.

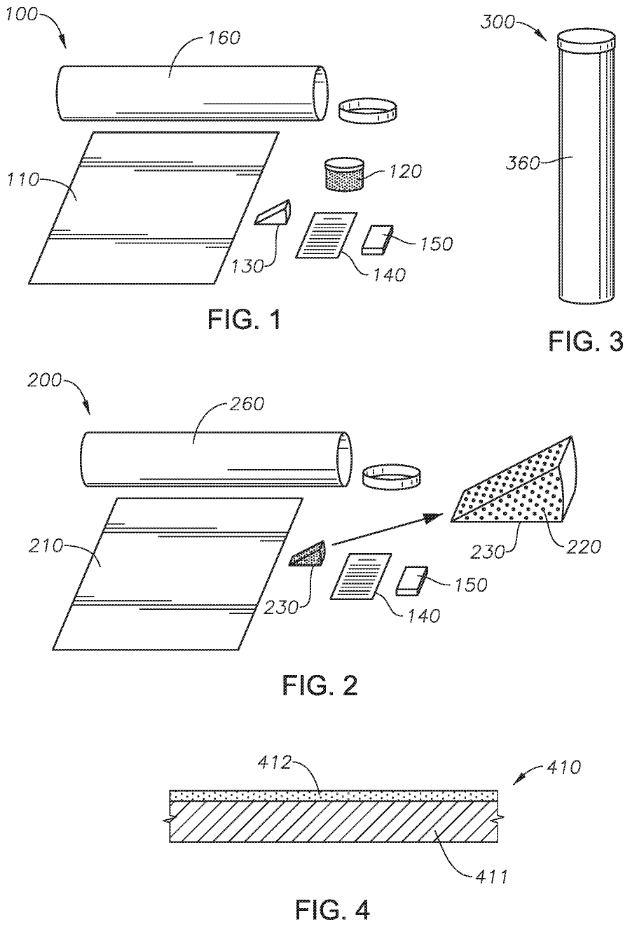

FIG. 1 is a pictorial representation of a kit 100 for making an imprint of a fish on paper. The kit 100 includes developer-coated paper 110, activation solution 120, an applicator 130, instructions 140 for making an imprint of a fish on the developer-coated paper 110, absorbent material 150 for cleaning and preparing a surface of the fish, and a container 160. The container 160 in this embodiment is a resealable hollow tube that has a hollow space sufficiently large to fit the developer-coated paper 110, activation solution 120, applicator 130, instructions 140, and absorbent material 150 within. One of ordinary skill in the relevant art will understand that the container 160 can have other shapes, and various types of packaging can be used. The activation solution 120 is provided in sealed packaging so that the activation agent of the activation solution 120 and the developer agent of the develop-coated paper 110 do not react prematurely. In some embodiments, the kit 100 can include a towelette (not shown) for cleaning hands after handling the fish and activation solution 120.

FIG. 2 is a pictorial representation of a kit 200 for making an imprint of a fish on paper similar to the embodiment of FIG. 1. The embodiment of the kit shown in FIG. 2 includes developer-coated paper 210, an activation solution-infused applicator 230, instructions 240 for making an imprint of a fish on the developer-coated paper 210, absorbent material 250 for cleaning and preparing a surface of the fish, and a container 260. The activation solution-infused applicator 230 is an applicator having absorbent material that is infused with activation solution 220. The activation solution-infused applicator 230 can be provided in sealed packaging so that the activation agent of the activation solution-infused applicator 230 does not prematurely react with the developer of the developer-coated paper 210. In at least one embodiment, the activation solution-infused applicator 230 includes crepe paper that has been soaked in an activation solution. In some embodiments, the kit 200 can include a towelette (not shown) for cleaning hands after handling the fish and activation solution.

FIG. 3 is a pictorial representation of a kit 300 for making an imprint of a fish on paper similar to the embodiments of FIG. 1 and FIG. 2, but with the developer-coated paper, activation solution, applicator, instructions, and absorbent material enclosed within the container 360. Because the kit 300 is contained in a single compact unit, it can be readily transported by fisherman on fishing excursions. The developer-coated paper having the imprint of the fish can be repackaged in the container 360 for easy transportation after an imprint of a fish is made. The container 360 protects its contents from elements that might ruin or disperse them, such as wind or precipitation.

FIG. 4 is a magnified view of an edge of developer-coated paper 410. The developer-coated paper has a developer coating 412 on at least one side of a paper substrate 411. The developer coating 412 has a developer agent.

A method for making an imprint of a fish can include preparing a surface of a fish with the absorbent material. The step of preparing the surface of the fish can include cleaning debris, water, mucus secretion, or combinations of the same from the surface of the fish. Preparing the surface of the fish can also include positioning the fish on a relatively dry surface. The surface of the fish can be any surface of the fish, including a side, tail, fin, bill, or combinations of the same.

After the surface of the fish has been prepared, the activation solution can be applied to the surface of the fish. In at least one embodiment, the activation solution can be applied to the surface of the fish without first preparing the surface of the fish with the absorbent material. The activation solution can be applied by brushing, rolling, wiping, spreading, or pouring the activation solution onto the surface of the fish. It is also contemplated that the activation solution can be sprayed onto the surface of the fish. In at least one embodiment, the applicator is infused with the activation solution to facilitate applying the activation solution to the surface of the fish. In at least one embodiment, the step of applying the activation solution to the surface of the fish includes cleaning the activation solution from the hands of the user.

The developer-coated paper is contacted with the surface of the fish after the activation solution is applied to the surface of the fish. Upon contacting with the surface of the fish, the activation agent of the activation solution reacts with the developer agent of the developer-coated paper to produce color and an imprint of the surface of the fish. In at least one embodiment the color-producing reaction between the developer agent and activation agent is nearly instantaneous (i.e., the color has formed in ten seconds or less). Where the color-producing reaction is nearly instantaneous, the developer-coated paper having the imprint of the surface of the fish can be handled after ten seconds of contacting the developer-coated paper with the surface of the fish without significantly altering how the imprint of the surface of the fish appears.

The activation solution in some embodiments can have low acute toxicity (i.e., LD₅₀ of at least 300 mg/kg). In at least one embodiment, the activation solution has LD₅₀ between about 300 mg/kg and about 2,000 mg/kg. In some embodiments, an imprint of a surface of a live fish can be made with an activation solution having low acute toxicity so that the fish can be safely returned to a body of water without harming the fish.

### EXAMPLE

The following example is included to demonstrate an embodiment of the disclosure, and should be considered nonlimiting. The techniques and compositions disclosed in the example represent techniques and compositions discovered to function well in the practice of the disclosure, and thus can be considered to constitute modes for its practice. However, changes can be made to the embodiments disclosed in the example without departing from the spirit and scope of the disclosure.

An imprint of a fish was made using a kit similar to the kit shown in FIG. 2. Following instructions provided with the kit, a side of a fish was cleaned and dried using gauze from the kit. A sealed applicator made from crepe paper and infused with an activation solution having a fluorane compound was provided with the kit and opened and used to apply the activation solution to the prepared surface of the fish. The activation solution had a LD₅₀ between about 300 mg/kg and about 2,000 mg/kg. After preparing the surface of the fish, the hands of the user were cleaned with an alcohol wipe that was provided with the kit to remove mucus secretion and activation solution. A developer-coated paper having a metal salt developer agent was provided with the kit. The developer-coated paper was contacted with the prepped surface of the fish. The color-producing reaction between the developer agent and activation agent was nearly instantaneous; the imprint of the surface of the fish appearing before the developer-coated paper and the surface of the fish were separated. The imprint of the surface of the fish showed sufficient detail to identify the species of the fish, anatomical parts of the fish, fins of the fish, and even individual scales of the fish. The developer-coated paper having the imprint of the surface of the fish was rolled as a scroll and returned to the container provided with the kit for safekeeping. The container was resealed to prevent damage during transportation.

I claim:

1. A kit for making an imprint of a surface of a fish, the kit comprising:
a developer-coated paper having a developer agent, a nonpigmented activation solution having an activation agent, an applicator, and a set of instructions for applying the activation solution to the surface of the fish with the applicator and making an imprint of the surface of the fish on the developer-coated paper; and
wherein the developer agent and activation agent are capable of reacting to produce color when combined, resulting in the imprint of the surface of the fish.

2. The kit of claim 1, wherein the nonpigmented activation solution has a median lethal dose that is in the range of 300-2,000 milligrams per kilogram (mg/kg).

3. The kit of claim 1, further comprising: a container sufficiently dimensioned for containing the developer-coated paper, nonpigmented activation solution, and applicator.

4. The kit of claim 3, wherein the container comprises a hollow cylinder that is dimensioned such that the developer-coated paper, nonpigmented activation solution, and activation agent can be contained within the hollow cylinder.

5. The kit of claim 1, wherein the applicator comprises an absorbent material having the nonpigmented activation solution infused therein; and wherein the applicator is provided in sealed packaging.

6. The kit of claim 1, further comprising: an absorbent material for absorbing moisture from the surface of the fish.

7. The kit of claim 1, where the set of instructions comprises species-specific instructions for applying the activation solution to the surface of the fish with the applicator and making an imprint of the surface of the fish on the developer-coated paper.

8. A method for making an imprint of a surface of a fish, the method comprising the steps of:
supplying a fish and a fish imprint kit, wherein the fish imprint kit comprises:
a developer-coated paper having a developer agent, a nonpigmented activation solution having an activation agent, an applicator, and a set of instructions for applying the activation solution to the surface of the fish with the applicator and making an imprint of the surface of the fish on the developer-coated paper; and
wherein the developer agent and activation agent are capable of reacting to produce color when combined;
applying the nonpigmented activation solution having the activation agent to a surface of the fish,
contacting the developer-coated paper having the developer agent with the surface of the fish such that the activation agent in the nonpigmented activation solution on the surface of the fish reacts with the developer agent of the developer-coated paper to produce color and form the imprint of the surface of the fish on the developer-coated paper.

9. The method of claim 8, wherein the activation agent and developer agent react to produce the color and form the imprint of the surface of the fish such that the imprint of the surface of the fish on the developer-coated paper can be handled after ten seconds of contacting the developer-coated paper with the surface of the fish without altering how the imprint of the surface of the fish appears.

10. The method of claim 8 or 9, wherein the step of contacting the surface of the fish with the developer-coated paper is carried out at ambient temperature.

11. The method of claim 8, wherein the nonpigmented activation solution has a median lethal dose that is in the range of 300-2,000 mg/kg.

12. The method of claim 8 or 11, wherein the fish is a live fish; and further comprising: the step of releasing the live fish into a body of water after contacting the surface of the live fish with the developer coated paper.

13. The method of claim 8, further comprising: removing moisture from the surface of the fish before applying the nonpigmented activation solution to the surface of the fish.

14. The method of claim 8, further comprising: removing mucus secretion from the surface of the fish before applying the nonpigmented activation solution to the surface of the fish.

15. The method of claim 8, wherein the step of applying the nonpigmented activation solution to the surface of the fish comprises wiping the nonpigmented activation solution onto the surface of the fish with an absorbent material.

16. The method of claim 8, wherein the surface of the fish is a surface of a bill of the fish.

17. The method of claim 8, wherein the surface of the fish is a surface of a fin of the fish.

18. The method of claim 8, wherein the surface of the fish is a surface of a tail of the fish.
